(19) United States
(12) Patent Application Publication
(10) Pub. No.: US 2006/0153963 A1
(43) Pub. Date: Jul. 13, 2006

(54) Squeezable fruit sauce and process for making same

(75) Inventor: Charles Morgan, Brockton, MA (US)

Correspondence Address: NIXON & VANDERHYE, PC, 901 NORTH GLEBE ROAD, 11TH FLOOR, ARLINGTON, VA, 22203, US

(73) Assignee: Ocean Spray Cranberries, Inc., Lakeville-Middleboro, MA (US)

(21) Appl. No.: 11/280,866

(22) Filed: Nov. 17, 2005

Related U.S. Application Data
(60) Provisional application No. 60/628,225, filed on Nov. 17, 2004.

(51) Int. Cl. A23L 1/40

(52) U.S. Cl. 426/589

(57) ABSTRACT

A squeezable fruit sauce containing less than 50% fruit. The sauce includes fruit and or fruit puree, water, sweetener, and a combination of pectins or thickeners. The ingredients combined to give a thin set sauce (30.0-40.0 Brix) with minor syneresis.

### CROSS-REFERENCES TO RELATED APPLICATIONS

This application claims the benefit of U.S. Provisional application No. 60/628,225, filed Nov. 17, 2004, incorporated herein by reference in its entirety.

### FIELD OF THE INVENTION

The present invention relates to a squeezable or thin set sauce resembling at least a portion of the properties of traditional cranberry sauce.

### BACKGROUND OF THE INVENTION

Cranberry fruit sauce along with other jellied sauces and jams have a consistency that makes them set into a semi solid state that is then spoonable and or spreadable. These are important attributes for these products.

Conventional jellied sauces or jams have higher levels of fruit and may or may not use pectins or gums as thickening agents. Usually as the fruit levels are lowered thickeners are either added or increased to obtain the same sufficient rigid set.

The addition of pectins or gums may have sensory disadvantages (poor taste, slick or gummy mouth feel etc.). Once the gel in a typical jellied sauce is broken there may be weeping or syneresis.

Accordingly, a need has developed for a lower viscosity, thin set fruit sauce to increase flowability and allow squeezing as a means of dispensing or spreading, e.g., via a squeeze bottle.

### BRIEF SUMMARY OF THE INVENTION

One aspect of the invention is directed to a unique blend of hydrocolloids that will provide a smooth, free flowing, squeezable sauce with very limited syneresis.

According to one embodiment of the invention, there is provided an edible composition containing (by weight based on the final composition consumed):

about 5-15% water

about 30-50% cranberry or fruit puree

about 30-50% sweetener

about 0.1-2.0% gel-forming hydrocolloids.

The above percentages (and all those described herein) may vary up to 5%-15% or more, depending on application. The resulting product may be in the form of a squeezable flowing sauce, e.g., cranberry sauce. The sweetener may take the form of corn syrup, or a sugar substitute having “low” or no calories.

According to another aspect of the invention, there is provided a method for making a squeezable sauce, comprising blending fruit and any sweetener components and heating; blending gel-forming hydrocolloids with water and/or dispersing gel-forming hydrocolloids in the sweetener; and cooking to evaporate water to a solids level of about 30-38 Brix.

In accordance with another aspect of the invention, there is provided a squeezable fruit sauce having low syneresis and made with gel-forming hydrocolloids. The sauce may include one or more of the following: a solids level of about 30-40 Brix; and/or a pH of about 2-4. Furthermore, the hydrocolloids may include one or more of the following: low methoxyl esterified pectin, esterified and amidated pectin and/or locust bean gum. Also, the sauce may be made with a sugarfree sweetener, or in the alternative, high fructose corn syrup or the like.

These and other aspects of the invention will be described in or apparent from the following detailed description.

### DETAILED DESCRIPTION OF THE INVENTION

Embodiments of the invention provide a thinner set cranberry or fruit sauce that is squeezable with low syneresis. The thin set sauce enables it to be dispensed using a squeeze bottle, which is convenient for consumers. The sauce is squeezable as a result of the increased flowability of the sauce, which can be achieved using, e.g., one or more hydrocolloids or other edible product thinners.

In one embodiment, the fruit sauce composition includes about 5-15% water, about 30-50% cranberry or fruit puree, about 30-50% sweetener and about 0.1-2.0% gel-forming hydrocolloids.

A process for the preparation of the fruit sauce includes blending fruit and any sweetener components and heating, blending gel-forming hydrocolloids with water and/or dispersing gel-forming hydrocolloids in the sweetener, and cooking to evaporate water to a solids level of about 30-38 Brix. The sauce is allowed to cool in order for the gel to set.

### EXAMPLE

An example of the product and process of the invention will now be described to illustrate, but not to limit, the invention.

10.6%—Water

45%—Cranberry Puree

36%—High fructose corn syrup

5%—Sucrose

1.4%—Cranberry concentrate

0.67%—Pectin (esterified, amidated)

0.14%—Locust bean gum

0.11—Pectin (low methoxyl, esterified)

0.07—Sodium Benzoate

Preparation Process

The ingredients of the above EXAMPLE were blended in 3 separate parts. Part one includes, and preferably consists of, the cranberry puree, cranberry concentrate, sucrose and sodium benzoate. Once blended, these ingredients are heated to 120-180° F., e.g., 150° F.

Part two includes, and preferably consists of, high fructose corn syrup and the Locust bean gum. Once blended they are added to part one in the cook kettle. However, it should be noted that it is not necessary to use high fructose corn syrup, as non-corn syrup substitutes are available with “low” or no calories.

Once part one and two are blended together they are brought to a temperature of 180-220° F., e.g., 200° F.

Part three includes, and preferably consists of, the water and hydrocolloids (e.g., one or more pectins and/or Locust bean gum). Once blended and inspected for lack of clumping, they are added to parts one and two in the cook kettle. The temperature is brought to about 195° F. and cooked to a Brix of 30-40, e.g., 34.0 to 35.0. The resulting pH should be about 2-4, and preferably about or exactly 2.9.

The product is then filled into a squeezable bottle or other container and cooled. A bottle appropriate for dispensing the squeezable fruit sauce is described in U.S. design patent no. 29/217,299, filed Nov. 16, 2004, incorporated herein by reference in its entirety.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the invention. For example, embodiments of the invention may also be applied to other cranberry or fruit blend sauces.

1. An edible thin set fruit sauce containing:
5-15% water;
30-50% cranberry or fruit puree;
30-50% sweetener; and
about 2.0% gel-forming hydrocolloids.

2. The sauce according to claim 1, wherein the sweetener is a blend of high fructose corn syrup and sucrose.

3. The sauce according to claim 1, wherein the gel forming hydrocolloids are a blend of low methoxyl esterified pectin, esterified and amidated pectin and locust bean gum.

4. The sauce according to claim 1, wherein the pH of the sauce is about 2-4.

5. The sauce according to claim 1, wherein the pH is about 2.9.

6. The sauce according to claim 1, wherein the a solids level of the sauce is about 30-40 Brix.

7. The sauce according to claim 6, wherein the solids level is about 34-35 Brix.

8. A squeezable fruit sauce having low syneresis and made with gel-forming hydrocolloids.

9. The sauce according to claim 8, wherein a solids level of the sauce is about 30-40 Brix.

10. The sauce according to claim 8, wherein the pH of the sauce is about 2-4.

11. The sauce according to claim 8, wherein the hydrocolloids include one or more of the following: low methoxyl esterified pectin, esterified and amidated pectin and/or locust bean gum.

12. The sauce according to claim 8, wherein the sauce is made with a sugarfree sweetener.

13. A process for the preparation of edible thin set fruit sauce, comprising:
blending fruit and any sweetener components and heating;
blending gel-forming hydrocolloids with water and/or dispersing gel-forming hydrocolloids in the sweetener; and
cooking to evaporate water to a solids level of about 30-38 Brix.

14. The sauce according to claim 13, wherein the fruit sauce includes:
5-15% water;
30-50% cranberry or fruit puree;
30-50% sweetener; and
0.1-2.0% gel-forming hydrocolloids.

15. The process as claimed in claim 13, further comprising:
filling and cooling the sauce; and
allowing a period of time for gel to set.
